(19) United States
(12) Patent Application Publication
(10) Pub. No.: US 2011/0087402 A1
(43) Pub. Date: Apr. 14, 2011

(54) Detection of Trailer Sway Utilizing Park Assist Sensors

(75) Inventor: Thomas A. Banks, Sterling Heights, MI (US)

(73) Assignee: Continental Teves, Inc.

(21) Appl. No.: 12/578,775

(22) Filed: Oct. 14, 2009

(51) Int. Cl. G06F 7/00

(52) U.S. Cl. 701/36

(57) ABSTRACT

An electronic stability control system includes a plurality of sensors that generate respective signals based on respective distances between a vehicle and a trailer that is being towed by the vehicle. A backup assistance module determines respective distances based on the signals. An electronic stability control (ESC) module controls a wheel torque of at least one of the vehicle and trailer based on the respective distances.

### FIELD

The present disclosure relates to automotive stability control systems and more particularly to adapting such systems to sense and compensate for towed trailers.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Some modern vehicles employ an electronic stability control (ESC) system that helps the driver avoid losing directional control of the vehicle. The ESC system employs one or more sensors that monitor yaw motion of the vehicle. The ESC controls road wheel torque and/or vehicle steering to help the driver maintain directional control when the yaw motion exceeds a predetermined threshold. The effectiveness of ESC may be hampered when the vehicle is towing a trailer.

### SUMMARY

An electronic stability control system includes a plurality of sensors that generate respective signals based on respective distances between a vehicle and a trailer that is being towed by the vehicle. A backup assistance module determines respective distances based on the signals. An electronic stability control (ESC) module controls a wheel torque of at least one of the vehicle and trailer based on the respective distances.

In other features the ESC module controls at least one of driveline torque and brake torque when controlling the wheel torque. The plurality of sensors sense the distances at least one of acoustically, optically, and electromagnetically. The ESC module controls the wheel torque of the at least one of the vehicle and trailer further based on at least one of amplitudes, slopes, and periods of the respective distances.

A stability control method includes generating signals based on respective distances between a vehicle and a trailer that is being towed by the vehicle, determining respective distances based on the signals, and controlling a wheel torque of at least one of the vehicle and trailer based on the respective distances.

In other features controlling the wheel torque further comprises controlling at least one of driveline torque and brake torque. Sensing the distances is performed at least one of acoustically, optically, and electromagnetically. Controlling the wheel torque of the at least one of the vehicle and trailer is further based on at least one of amplitudes, slopes, and periods of the respective distances over a period of time.

An electronic stability control system includes sensor means for generating signals based on respective distances between a vehicle and a trailer that is being towed by the vehicle, backup assistance means for determining respective distances based on the signals, and stability control means for controlling a wheel torque of at least one of the vehicle and trailer based on the respective distances.

In other features the stability control means controls at least one of driveline torque and brake torque when controlling the wheel torque. The sensor means sense the distances at least one of acoustically, optically, and electromagnetically. The stability control means controls the wheel torque of the at least one of the vehicle and trailer further based on at least one of amplitudes, slopes, and periods of the respective distances.

A computer readable memory includes instructions for a processor wherein the instructions implement a stability control method. The method includes generating signals based on respective distances between a vehicle and a trailer that is being towed by the vehicle, determining respective distances based on the signals, and controlling a wheel torque of at least one of the vehicle and trailer based on the respective distances.

In other features controlling the wheel torque further comprises controlling at least one of driveline torque and brake torque. Sensing the distances is performed at least one of acoustically, optically, and electromagnetically. Controlling the wheel torque of the at least one of the vehicle and trailer is further based on at least one of amplitudes, slopes, and periods of the respective distances over a period of time.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a trailer and a tow vehicle that is equipped with an ESC (electronic stability control) module;

FIGS. 2A and 2B are functional block diagrams of the trailer and the tow vehicle while the trailer is swaying left and right of the vehicle, respectively; and

FIG. 3 is a graph of trailer sway measurements that are employed by the ESC module.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

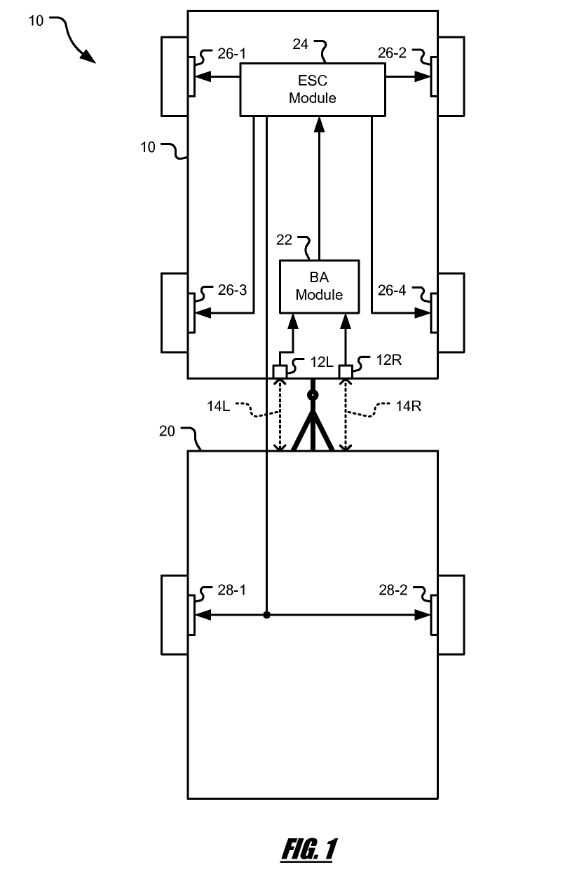

Referring now to FIG. 1, a functional block diagram is shown of a vehicle 10 that is equipped with left and right distance sensors, 12L and 12R, respectively. Left and right sensors 12L and 12R may also be referred to collectively as sensors 12. Sensors 12 generate signals based on respective distances 14L and 14R between sensors 12 and respective surfaces of trailer 20. Distances 14L and 14R are then employed by electronic stability control (ESC) module 24 to detect and control swaying of trailer 20.

Sensors 12 can be part of a backup assistance (BA) system as is known in the art. A BA module 22 can receive signals from sensors 12 and, based on the signals, determine the distances 14L and 14R. Sensors 12 can employ acoustic, radiofrequency, and/or optical measuring technology as is known in the art.

An electronic stability control (ESC) module 24 controls the torques of associated vehicle wheels 26-1, 26-2, . . . , 26-4 and/or trailer wheels 28-1, 28-2. The torques are based on the magnitudes and rates of change of distances 14L and 14R. Vehicle wheels 26-1, 26-2, . . . , 26-4 may also be referred to collectively as vehicle wheels 26. Trailer wheels 28-1, 28-2 may also be referred to collectively as trailer wheels 28.

ESC module 24 can individually change the torque of each of vehicle wheels 26 and/or trailer wheels 28 by manipulating braking force and/or driveline torque using methods that are known in the art. It should be appreciated that the functionalities of ESC module 24 and BA module 22 may be combined into a single module. It should also be appreciated that while vehicle 10 is shown as having four wheels 26 and trailer 20 is shown as having two wheels 28, other numbers of wheels 26, 28 may be used.

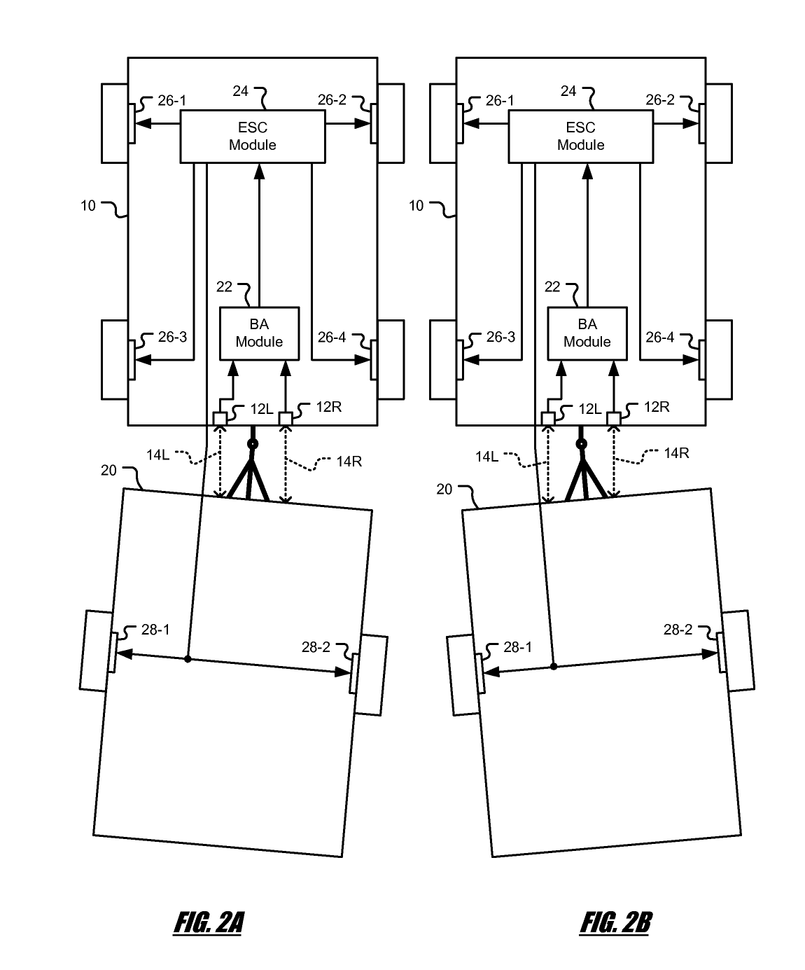

Referring now to FIGS. 2A and 2B, trailer 20 is shown angularly displaced, left and right respectively, from a longitudinal centerline of vehicle 10. Such angular displacement can inadvertently occur to varying amplitudes and rates of change depending on whether vehicle 10 is skidding, trailer 20 is swaying, and the like. Distances 14L and 14R change based on the angular displacement and they are employed by ESC module 24. ESC module 24 controls the torques of vehicles wheels 26 and/or trailer wheels 28 to correct the skidding and/or swaying conditions.

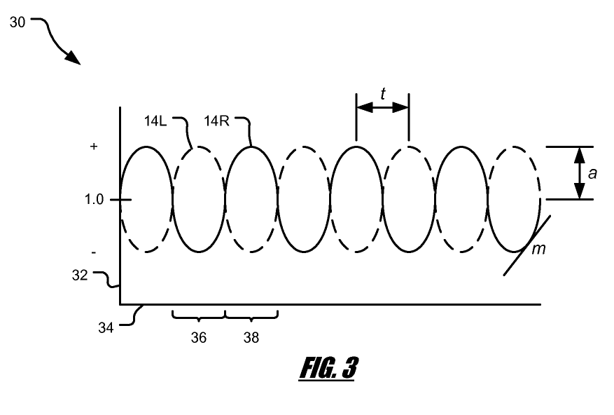

Referring now to FIG. 3, a graph 30 shows an example of distances 14L and 14R changing as trailer 20 sways. A vertical axis 32 represents normalized distance. A horizontal axis 34 represents time. Traces on graph 30 represent the distances 14L and 14R as trailer 20 sways. It should be appreciated that the traces take on different shapes depending on how well trailer 20 is tracking vehicle 10.

During a first time period 36 trailer 20 is swaying right of vehicle 10 such as is depicted in FIG. 2B. Distance 14L is greater than distance 14R. During a second time period 38 trailer 20 is swaying left of vehicle 10 such as is depicted in FIG. 2A. Distance 14L is less than distance 14R. ESC module 24 employs the distances 14L and 14R to infer the lateral stability of vehicle 10 and/or trailer 20 and to take correction action to improve stability. ESC module 24 may infer the later stability based on amplitudes a, durations t, and/or slopes m of distances 14L and 14R.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. An electronic stability control system, comprising:
a plurality of sensors that generate respective signals based on respective distances between a vehicle and a trailer that is being towed by the vehicle;
a backup assistance module that determines respective distances based on the signals; and
an electronic stability control (ESC) module that controls a wheel torque of at least one of the vehicle and trailer based on the respective distances.

2. The electronic stability control system of claim 1 wherein the ESC module controls at least one of driveline torque and brake torque when controlling the wheel torque.

3. The electronic stability control system of claim 1 wherein the plurality of sensors sense the distances at least one of acoustically, optically, and electromagnetically.

4. The electronic stability control system of claim 1 wherein the ESC module controls the wheel torque of the at least one of the vehicle and trailer further based on at least one of amplitudes, slopes, and periods of the respective distances.

5. A stability control method, comprising:
generating signals based on respective distances between a vehicle and a trailer that is being towed by the vehicle;
determining respective distances based on the signals; and
controlling a wheel torque of at least one of the vehicle and trailer based on the respective distances.

6. The method of claim 5 wherein controlling the wheel torque further comprises controlling at least one of driveline torque and brake torque.

7. The method of claim 5 wherein sensing the distances is performed at least one of acoustically, optically, and electromagnetically.

8. The method of claim 5 wherein controlling the wheel torque of the at least one of the vehicle and trailer is further based on at least one of amplitudes, slopes, and periods of the respective distances over a period of time.

9. An electronic stability control system, comprising:
sensor means for generating signals based on respective distances between a vehicle and a trailer that is being towed by the vehicle;
backup assistance means for determining respective distances based on the signals; and
stability control means for controlling a wheel torque of at least one of the vehicle and trailer based on the respective distances.

10. The electronic stability control system of claim 9 wherein the stability control means controls at least one of driveline torque and brake torque when controlling the wheel torque.

11. The electronic stability control system of claim 9 wherein the sensor means sense the distances at least one of acoustically, optically, and electromagnetically.

12. The electronic stability control system of claim 9 wherein the stability control means controls the wheel torque of the at least one of the vehicle and trailer further based on at least one of amplitudes, slopes, and periods of the respective distances.

13. A computer readable memory that includes instructions for a processor wherein the instructions implement a stability control method, comprising:
generating signals based on respective distances between a vehicle and a trailer that is being towed by the vehicle;
determining respective distances based on the signals; and
controlling a wheel torque of at least one of the vehicle and trailer based on the respective distances.

14. The method of claim 13 wherein controlling the wheel torque further comprises controlling at least one of driveline torque and brake torque.

15. The method of claim 13 wherein sensing the distances is performed at least one of acoustically, optically, and electromagnetically.

16. The method of claim 13 wherein controlling the wheel torque of the at least one of the vehicle and trailer is further based on at least one of amplitudes, slopes, and periods of the respective distances over a period of time.
